(19) United States
(12) Patent Application Publication
(10) Pub. No.: US 2009/0257510 A1
(43) Pub. Date: Oct. 15, 2009

(54) System and Method for Programmable Pre-Amplification of a Signal

(76) Inventors: William Russell THOMAS, Dundas (CA); Vasilis Papanikolaou, Toronto (CA); David Richard Brown, Burlington (CA)

Correspondence Address: PATENT GROUP 2N;JONES DAY, NORTH POINT, 901 LAKESIDE AVENUE, CLEVELAND, OH, 44114, US

(21) Appl. No.: 12/421,708

(22) Filed: Apr. 10, 2009

Related U.S. Application Data
(60) Provisional application No. 61/044,119, filed on Apr. 11, 2008.

(51) Int. Cl. H04N 7/12

(52) U.S. Cl. 375/240.25; 375/E07.027

(57) ABSTRACT

Systems and methods are provided for communicating a data signal. A data signal is transmitted along a communications line. The transmitted data signal is split among a plurality of routers, each router configured to receive the data signal and forward the data signal along one or more output data paths. The data signal is received at a destination, and flat-band amplification is provided to the received data signal via a selectable gain amplifier. A frequency dependent amplification is provided to the received data signal via an equalizer. The amplified received signal is then decoded.

This application claims the benefit of U.S. Provisional Application No. 61/044,119, filed Apr. 11, 2008, entitled, “System and Method for Programmable Pre-Amplification of a Signal,” the entirety of which is herein incorporated by reference.

### FIELD

The technology described in this patent application relates generally to the field of digital audio/video signal processing. More particularly, the application describes a system and method for the application of variable pre-amplification to a signal.

### BACKGROUND

Audio/visual and other data signals are often transmitted via wired communication media such as through co-axial, fiber optic, or other cabling types. The use of such transmission media often introduces frequency dependent signal degradation. For example, a transmitted signal may be affected by signal dispersion and inter-signal interference that attenuates the high-frequency content of the original signal. This high-frequency loss is predominantly caused by the “skin effect,” as well as through dielectric losses in the cable and other associated connectors and interconnect. Much less common are frequency independent degradations across all frequency components of a transmitted signal.

### SUMMARY OF THE INVENTION

In accordance with the teachings provided herein, systems and methods are provided for communicating a data signal. The systems and methods may include transmitting the data signal along a communications line and splitting the transmitted data signal among one or more routers, each router configured to receive the data signal and forward the data signal along one or more output data paths. The data signal is received at a destination and flat-band amplification may be provided to the received data signal via a selectable gain. Frequency dependent amplification may also be provided to the received data signal via an equalizer. The amplified received data signal may then be decoded.

As an additional example, a method of receiving a serial digital interface (SDI) signal may include receiving an SDI signal transmitted at a launch swing below a prescribed launch swing standard and detection of the SDI signal being transmitted at the launch swing below the prescribed launch swing standard. Flat-band amplification may be provided to the received SDI signal via a selectable gain amplifier, and frequency dependent amplification may be provided to the received SDI signal via an equalizer. The amplified received SDI signal may then be decoded.

As another example, a system for communicating a data signal may include a transmitter configured to transmit a data signal along a co-axial communications line. One or more may split the transmitted data signal, where each router is configured to receive the data signal and forward the data signal along one or more output data paths. The system may further include a receiver and a selectable gain amplifier configured to provide flat-band amplification to the received data signal. An equalizer may also be included to provide frequency dependent amplification to the received data signal, and a decoder may be configured to decode the amplified received data signal.

As a further example, a system for applying selectable pre-amplification to an SDI signal may include an SDI signal receiver configured to receive an SDI signal from a connected co-axial cable transmission line. The SDI signal receiver may further include a transmission launch swing detector configured to identify whether the received SDI signal was transmitted at a launch swing below a prescribed launch swing standard. The receiver may also include a flat-band amplifier configured to amplify the received SDI signal according to a selectable gain upon detection that the received SDI signal was transmitted at the launch swing below the prescribed launch swing standard. An equalizer may also be included to provide frequency dependent amplification to the received SDI signal along with a decoder for decoding the amplified received SDI signal.

### BRIEF DESCRIPTION OF THE DRAWINGS

FIG. 1 is a block diagram depicting a data signal transmission path that includes a selectable gain flat-band amplifier preceding an equalizer.

FIG. 2 is a block diagram depicting a data signal transmission path that includes a flat-band attenuation generating split.

FIG. 3 is a block diagram depicting a data signal transmission path that includes a return loss network.

FIG. 4 is a block diagram depicting the transmission of a data signal via a connected transmission media through a splitting router.

FIG. 5 is a block diagram depicting the transmission of a data signal via a connected transmission media through a series of splitting routers.

FIG. 6 is a block diagram depicting a low launch swing transmitter transmitting data signals to an equalizing receiver.

FIG. 7 is a block diagram depicting a standard compliant transmitter transmitting a data signal with a low launch swing to an equalizing receiver.

FIG. 8 is a block diagram depicting an equalizing receiver having a selectable gain flat-band amplifier that is controllable via a switch.

FIG. 9 is a block diagram depicting an equalizing receiver having a selectable gain flat-band amplifier that is controllable via a plurality of switches.

FIG. 10 is a block diagram depicting an equalizing receiver having a selectable gain flat-band amplifier that is controllable via a register bank.

FIG. 11 is a block diagram depicting an equalizing receiver having a selectable gain flat-band amplifier that is controllable via integration of a gain specific part.

FIG. 12 is a block diagram depicting an equalizing receiver having a selectable gain flat-band amplifier that is controllable via a feedback loop.

FIG. 13 is a block diagram depicting an equalizing receiver having a selectable gain flat-band amplifier that is controllable via a feedback loop that includes an analog comparator.

FIG. 14 is a flow diagram depicting a method for communicating a data signal.

FIG. 15 is a flow diagram depicting a method for receiving a serial digital interface signal.

### DETAILED DESCRIPTION

As described above, transmission of audio/visual and other data signals via connected transmission media often introduces frequency-dependent attenuation and degradation. There are limited applications where the signal propagating between the transmitting and receiving equipment may also undergo flat-band attenuation, which brings the signal amplitude outside of standardized compliance limits. Additionally, the signal may, intentionally or unintentionally, be transmitted below a prescribed transmission standard level. In such cases, receiving equipment may not be capable of recovering the received signal without introducing bit errors or otherwise compromising the data integrity of the system.

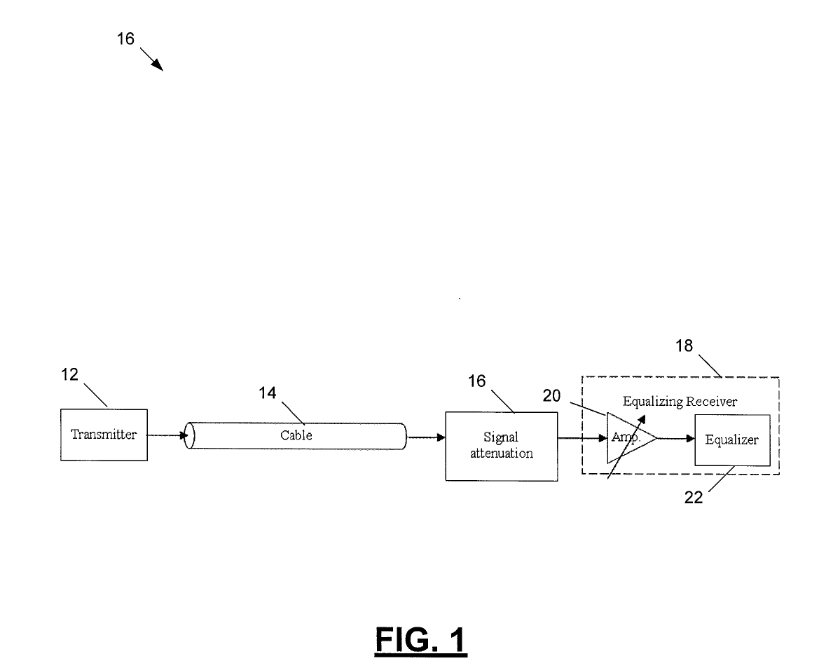

FIG. 1 is a block diagram depicting a data signal transmission path that includes a selectable gain flat-band amplifier preceding an equalizer. A transmitter 12 transmits a data signal, such as an audio/visual data signal, along a transmission cable 14. For example, the cable 14 may be a co-axial cable, a fiber optic cable, a Category 5 cable, etc. The transmitted data signal may be subjected to one or more types of signal attenuation during transmission, as indicated at 16. This signal attenuation may be either or both of frequency dependent attenuation or frequency independent attenuation. Frequency dependent attenuation may include signal degradations caused by the skin-effect of the transmission medium, inter-symbol interference, as well as other causes. Frequency independent attenuation is less common. Causes of frequency independent attenuation include applying the data signal to a resistive network or otherwise splitting the data signal. In the example of FIG. 1, after passing through the transmission cable 14, the data signal is received at an equalizing receiver 18. The equalizing receiver 18 may include a selectable gain flat-band amplifier 20 for providing flat-band amplification to the received data signal followed by an equalizer 22 for providing frequency specific amplification. Alternatively, the selectable gain flat-band amplifier 20 may apply flat-band attenuation instead of gain.

The equalizing receiver 18 may be implemented as a stand-alone or as a complement to other circuitry such as a serial digital interface (SDI) cable equalizer. The equalizing receiver 18 may be employed with current or future equalizers such as the GS1524/1574/2974/2984 available from Gennum Corporation of Burlington, Ontario, Canada. The equalizing receiver 18 may also be used in implementations that include an equalizing deserializer, integrated cable equalizer with reclocker, as well as others.

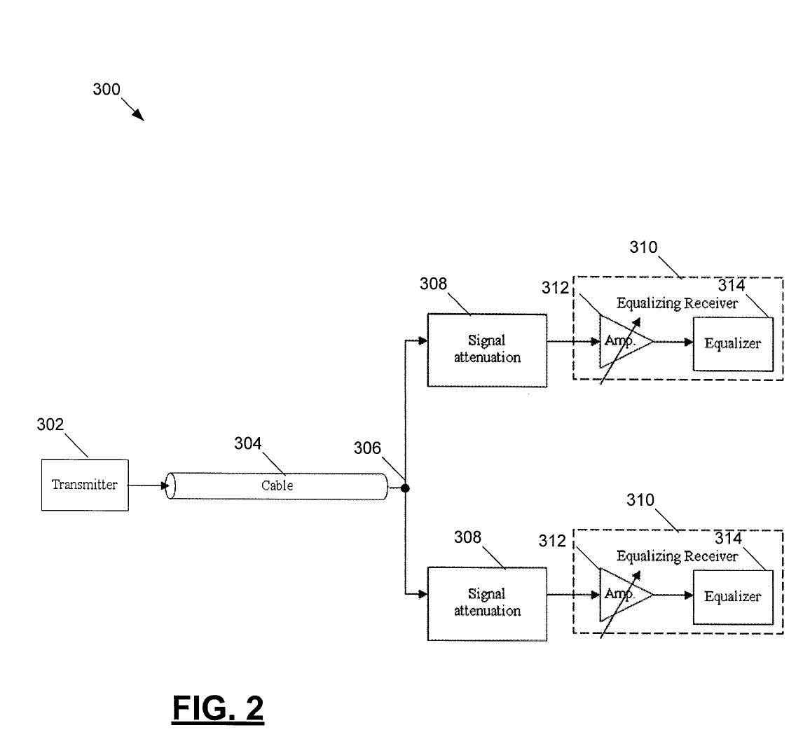

FIG. 2 is a block diagram depicting a data signal transmission path that includes a flat-band attenuation generating split. A transmitter 302 transmits a data signal, such as an audio/visual data signal, along a transmission cable 304. Prior to receipt, the transmission signal is split between two or more transmission lines, as shown at 306. Such a split may occur within a router or elsewhere in an audio/visual broadcast system resulting in a flat-band loss. In addition to attenuation encountered at the transmission line split 306, additional frequency independent and/or frequency dependent attenuation may be encountered within the transmission lines, as indicated at 308. In the example of FIG. 2, after passing through the transmission cables 304, the data signal is received at equalizing receivers 310. The equalizing receivers 310 may include a selectable gain flat-band amplifier 312 for providing flat-band amplification to the received data signal followed by an equalizer 314 for providing frequency specific amplification.

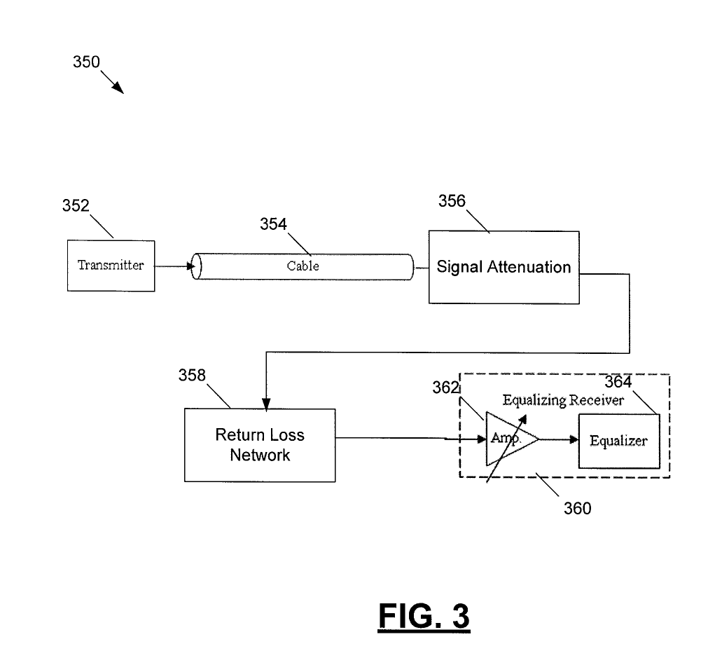

FIG. 3 is a block diagram depicting a data signal transmission path that includes a return loss network. A transmitter 352 transmits a data signal, such as an audio/visual data signal, along a transmission cable 354. Frequency independent and/or frequency dependent attenuation may be encountered within the transmission lines, as indicated at 356. In the example of FIG. 3, after passing through the transmission cables 354, the data signal travels a return loss network 358. Flat band attenuation may be beneficial prior to a return loss network to achieve better input return loss performance. Following the return loss network 358, the data signal is received at an equalizing receiver 360, which may compensate for, among other things, any flat-band loss intentionally incorporated into the system. The equalizing receiver 360 may include a selectable gain flat-band amplifier 362 for providing flat-band amplification to the received data signal followed by an equalizer 364 for providing frequency specific amplification.

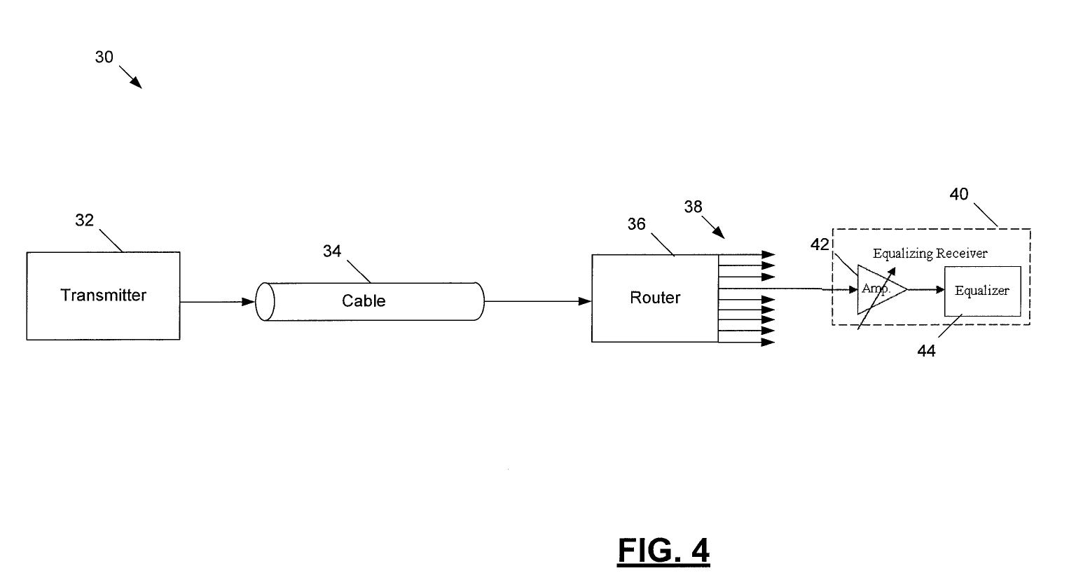

FIG. 4 is a block diagram depicting the transmission of a data signal via a connected transmission media through a splitting router. A transmitter 32 transmits a data signal via a connected transmission cable 34. The data signal is received at a splitting router 36. The splitting router 36 may identify from a portion of the received data signal the proper destination for the data signal. For example, the splitting router 36 may examine routing data in a layered transmission packet to identify a proper signal destination and may then forward the transmission packet along a proper output data path 38. Alternatively, the splitting router 36 may broadcast the received data signal on multiple or all of the splitting router's output data paths 38. Signal attenuation and/or degradation may be introduced at the splitting router 36. For example, splitting the received data signal along multiple output data paths 38 may introduce flat-band attenuation if no corresponding amplification is applied at the splitting router. However, such flat-band attenuation may be acceptable if the data signal is then received at an equalizing receiver 40 such as is depicted in FIG. 4. The equalizing receiver 40 includes a selectable gain flat-band amplifier 42 that may compensate for the flat-band attenuation introduced at the splitting router 36 or elsewhere in the transmission chain. Providing such flat-band amplification at the equalizing receiver 40 enables the splitting router 36 to be implemented without additional amplification, gaining power and cost savings at the splitting router 36. The equalizing receiver 40 may also include an equalizer 44 for compensating for frequency dependent signal degradations encountered through the transmission chain.

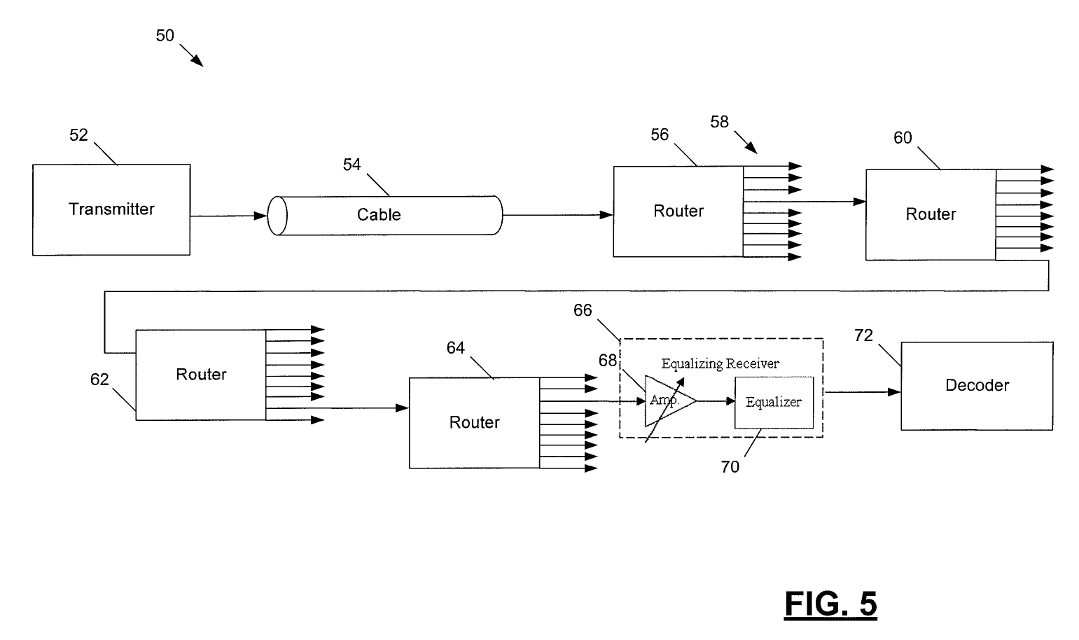

FIG. 5 is a block diagram depicting the transmission of a data signal via a connected transmission media through a series of splitting routers. A transmitter 52 transmits a data signal along a connected transmission cable 54. The transmitted data signal is received at a first splitting router 56. The first splitting router 56 forwards the received data signal along one or more of the first splitting router's output data paths 58. The data signal is then received at a second splitting router 60 that forwards the received data signal along one or more output data paths to a third splitting router 62. The third splitting router 62 forwards the received data signal along one or more output data paths to a fourth splitting router 64. The fourth splitting router forwards the received data signal along one or more output data paths, one of the output data paths being connected to an equalizing receiver 66. The equalizing receiver 66 includes a selectable gain flat-band amplifier for providing flat-band amplification to the received data signal. Flat band attenuation may be introduced at each of the splitting routers 56, 60, 62, 64, especially where signal amplification to complement for the router splits is not applied at the router level. The selectable gain flat-band amplifier 68 may be configured to restore the received data signal to an acceptable level in compensation for the flat-band attenuation encountered at the routers 56, 60, 62, 64. The equalizing receiver 66 may also include an equalizer 70 for providing frequency dependent amplification to the received data signal. The transmission chain 50 may further include a decoder 72 or other downstream circuitry for processing the amplified received signal.

An equalizing receiver may also be useful in conjunction with a transmitter that is transmitting data signals with a low launch swing. A launch swing is indicative of a power level at which a transmitter propagates a data signal along a transmission medium. Typically, a transmitter and a receiver will agree on a given launch swing prior to transmission. This agreement enables proper electronics to be implemented in the transmission chain to ensure that data is received at a receiver with limited errors. For example, a transmitter and receiver may agree that data is to be transmitted at 800 mV. Thus, the receiver will expect to receive data signals at or near 800 mV, being prepared to adjust for losses encountered through the transmission chain. The use of standards may facilitate easy negotiation of launch swing requirements among communicating parties by prescribing specific transmission signal levels for certain types of signals. Errors may arise if a transmitter transmits data signals at a lower than expected launch swing. For example, if a transmitter transmits a data signal at 400 mV when a receiver is expecting an 800 mV signal, the receiver may not be able to sufficiently compensate and recover the transmitted data.

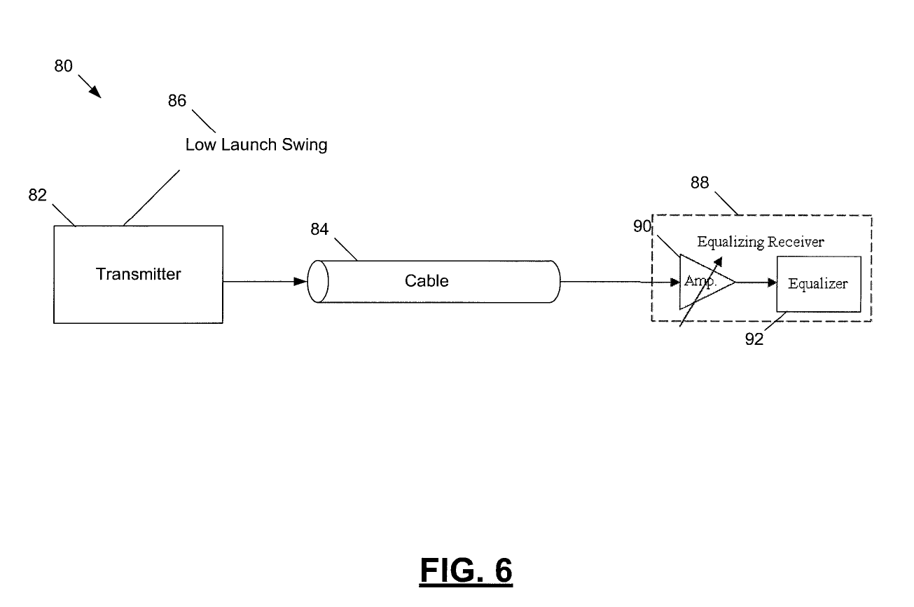

FIG. 6 is a block diagram depicting a low launch swing transmitter transmitting data signals to an equalizing receiver. A transmitter 82 transmits a data signal along a connected transmission cable 84 at a low launch swing, as indicated at 86. For example, the transmitter 82 may transmit a data signal at a lower launch swing than agreed upon by the transmitter and receiver, or the low launch swing transmission may be by design and known to the receiver. An equalizing receiver 88 receives the data signal. A selectable gain flat-band amplifier 90 provides flat-band amplification to the received data signal and an equalizer 92 provides frequency dependent amplification. The ability to compensate for expected or unexpected low launch swing transmissions through selectable gain flat-band amplification creates a launch swing independent equalizer that may adapt to differing launch swing conditions.

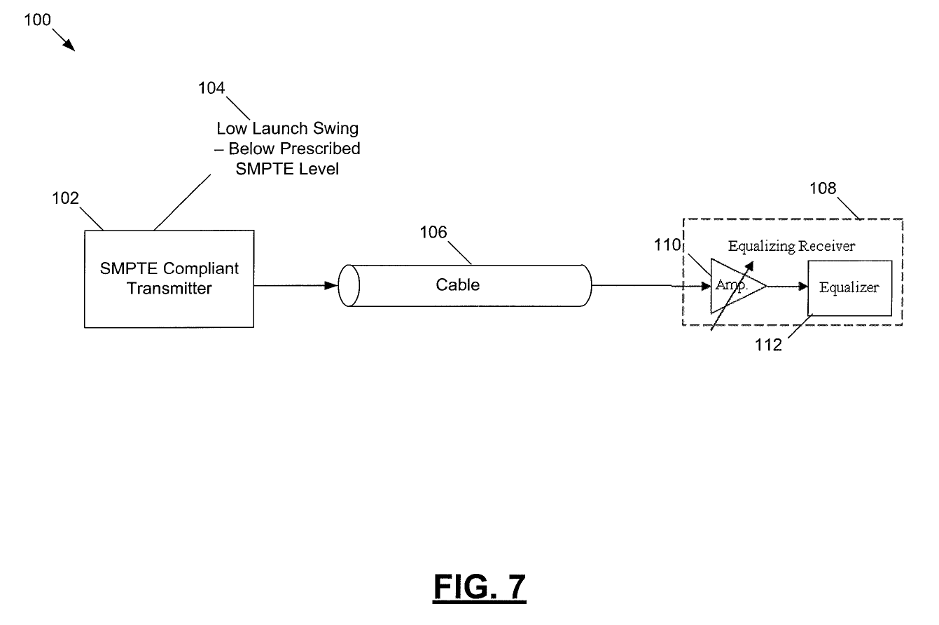

FIG. 7 is a block diagram depicting a standard compliant transmitter transmitting a data signal with a low launch swing to an equalizing receiver. A transmitter 102 designed to be able to transmit according to a Society of Motion Picture and Television Engineer's (SMPTE's) standard for data transmission propagates a data signal at a launch swing lower than that prescribed by the standard, as indicated at 104, along a cable 106. For example, the transmitter 102 may transmit at the lower launch swing as a power and/or cost saving measure that may or may not be known to a receiver 108. The low launch swing signal is received at the equalizing receiver 108. The equalizing receiver 108 includes a selectable gain flat-band amplifier 110 that provides flat-band amplification to the received data signal, aiding in data recovery from the low launch swing signal. An equalizer 112 provides frequency dependent amplification to the received data signal. Other transmission standards that may be implemented include TMDS, DVI, etc.

A variety of cable equalizer products for SDI applications are available from a number of companies, such as Gennum, National Semiconductor, Mindspeed, and Cyprus. The nature of these cable equalizers is that they assume a particular launch swing in order to determine the amount of equalization required. As noted above, the launch swing may differ from an expected value or there may be other elements in the transmission chain that affect the input swing seen by a receiving equalizer. The inclusion of a pre-amplifier, such as the selectable gain flat-band amplifier 110 of FIG. 7, that permits programmable gain, user-selectable gain, logic-selectable gain, or simply different gain, enables “zeroing out” of any transmission chain attenuation and compensation for a low launch swing. An additional benefit of pre-amplification before equalization to serial digital interfaces is that it allows for good matching between differential signal paths that may be well controlled across process, voltage, and temperature, allowing accurate zeroing-out of attenuation.

The pre-equalization gain applied to the signal as described in FIG. 7 provides a flat gain to boost the data signal amplitude to a level commensurate with system specifications as may be published by international standards bodies or trade organizations. For example, for system SDI links used in the television broadcast industry, the Society of Motion Picture and Television Engineers publishes standards which, among other things, define the launch swing of signals generated at one end of a co-axial cable. Generating equipment is certified according to compliance to these standards and has been in use in the field for many years. Similarly, an equalizer at the other end of a co-axial cable may be designed to compensate for signal dispersion and ISI by attenuating the high-frequency content of the original signal. This high-frequency loss is predominantly caused by the “skin effect,” dielectric losses in the cable, and other losses associated with connectors and interconnections. In order to restore the signal properly without introducing data bit errors, such equalizers rely on the low-frequency signal amplitude remaining within the specification limits set by the aforementioned industry standards. As noted above, there are applications where the signal propagating between the transmitting and receiving equipment may have undergone flat-band attenuation, which brings the signal amplitude outside of the standardized compliance limits. In such cases, the receiving equipment would likely not be capable of recovering the received signal without introducing bit errors, or otherwise compromising the data integrity of the system.

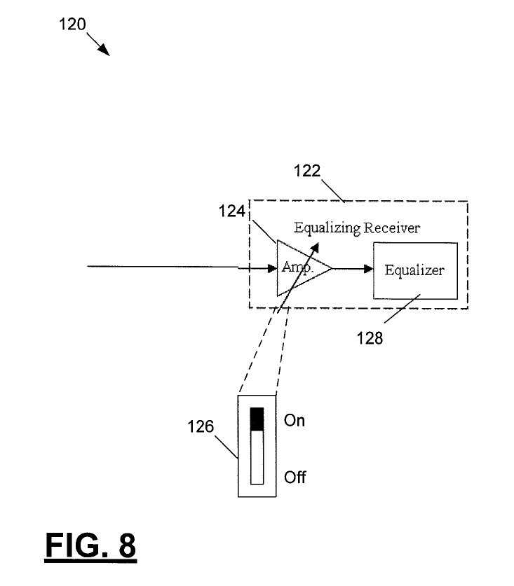

Thus, pre-amplification may be used to restore the signal amplitude with a flat gain such that the signal passed on to the integrated equalization stage falls within the standardized compliance limits expected by receiving equipment that will be deployed in the field. Active integrated circuit components can be used to implement the flat gain applied to the signal prior to equalization. Various means can be employed to set the flat gain to a quantity which matches the inverse of the attenuation introduced between the standards-compliant signal generator and the equalizing receiver. This circuit can be controlled externally to set the flat gain appropriately for the specific application, allowing the receiving equalization stage to operate either with standards-compliant equipment, or with systems in which a standards-compliant signal has been attenuated and can no longer be considered compliant to the relevant system standard. The system operator may have a priori knowledge of the magnitude of the flat-band attenuation applied to the signal, and that the flat-band gain applied within the integrated pre-amp/equalizing receiver can be programmed to match the magnitude of the signal attenuation, within the allowable limits of the relevant system standards. Alternatively, a feedback or other mechanism may be utilized to properly set a flat-band amplification level. Example mechanisms for selecting a gain level are described in FIGS. 8-13.

FIG. 8 is a block diagram depicting an equalizing receiver having a selectable gain flat-band amplifier that is controllable via a switch. A transmitted data signal is received by an equalizing receiver 122. The equalizing receiver 122 includes a selectable gain flat-band amplifier 124 for providing flat-band amplification to the received data signal. The flat-band amplifier 124 is controlled via a single toggle switch 126 that includes an on and off position. The flat-band amplifier 124 may be configured to apply a first level of flat-band amplification when the toggle switch 126 is in the off position and a second level of flat-band amplification when the toggle switch 126 is in the on position. Alternatively, the flat-band amplifier 124 may be configured to apply no gain when the toggle switch 126 is in the off position and a first level of flat-band gain when the toggle switch 126 is in the on position. The equalizing receiver 122 also includes an equalizer 128 for providing frequency dependent amplification to the received data signal. The configuration of FIG. 8 may be useful in a variety of contexts including where whether a transmitter will or will not be transmitting with a low launch swing is known prior to transmission, where a user may turn the flat-band amplifier on or off accordingly. In addition to a switch, other discrete mechanical selection mechanisms may be implemented.

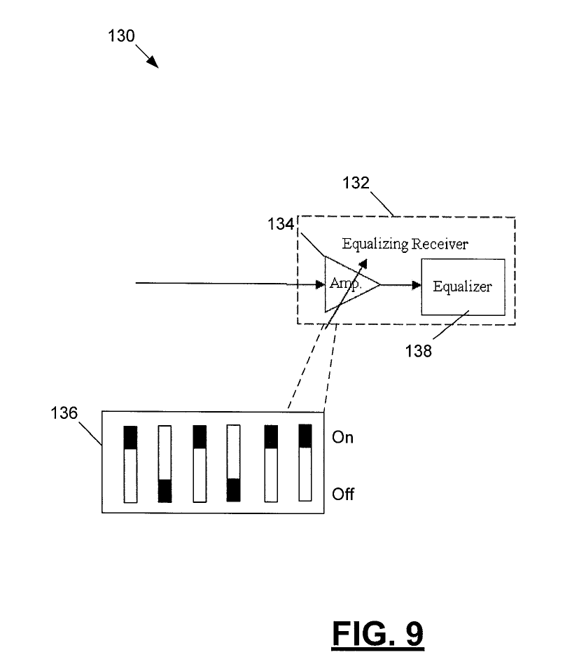

FIG. 9 is a block diagram depicting an equalizing receiver having a selectable gain flat-band amplifier that is controllable via a plurality of switches. A transmitted data signal is received by an equalizing receiver 132. The equalizing receiver 132 includes a selectable gain flat-band amplifier 134 for providing flat-band amplification to the received data signal. The flat-band amplifier 134 is controlled via a plurality of toggle switches 136 that each include an on and off position. The flat-band amplifier 134 may be configured to apply a level of flat-band amplification according to the positions of the plurality of toggle switches 136. The addition of toggle switches enables exponential gains in the number of gain levels that may be implemented by the flat-band amplifier 134. For example, six toggle switches 136 enable addressing of 2⁶=64 gain levels. The equalizing receiver 132 also includes an equalizer 138 for providing frequency dependent amplification to the received data signal. The configuration of FIG. 9 may be useful in a variety of contexts including where needed flat-band gain levels are not known and system administrator adjustments and tweaks are required. An equalizing receiver may utilize other discrete gain level selection mechanisms or may implement continuous analog mechanisms such as a potentiometer.

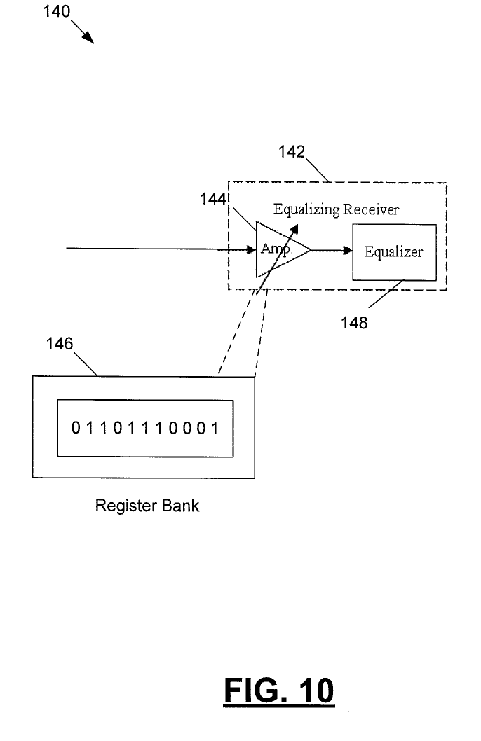

FIG. 10 is a block diagram depicting an equalizing receiver having a selectable gain flat-band amplifier that is controllable via a register bank. A transmitted data signal is received by an equalizing receiver 142. The equalizing receiver 142 includes a selectable gain flat-band amplifier 144 for providing flat-band amplification to the received data signal. The flat-band amplifier 144 is controlled via a register bank 146 that includes a number of gain level bits. The flat-band amplifier 144 may be configured to apply a level of flat-band amplification according to the value contained in the register bank 146. The addition of additional register bank bits enables exponential gains in the number of gain levels that may be implemented by the flat-band amplifier 144. For example, eleven register bank bits enable addressing of 2¹¹=2048 gain levels. The equalizing receiver 142 also includes an equalizer 148 for providing frequency dependent amplification to the received data signal. The configuration of FIG. 10 may be useful in a variety of contexts including where many potential gain levels may be required. The configuration of FIG. 10 also enables easy processor interface for the equalizing receiver by allowing the processor to control gain settings through manipulation of data values contained in the register bank 146.

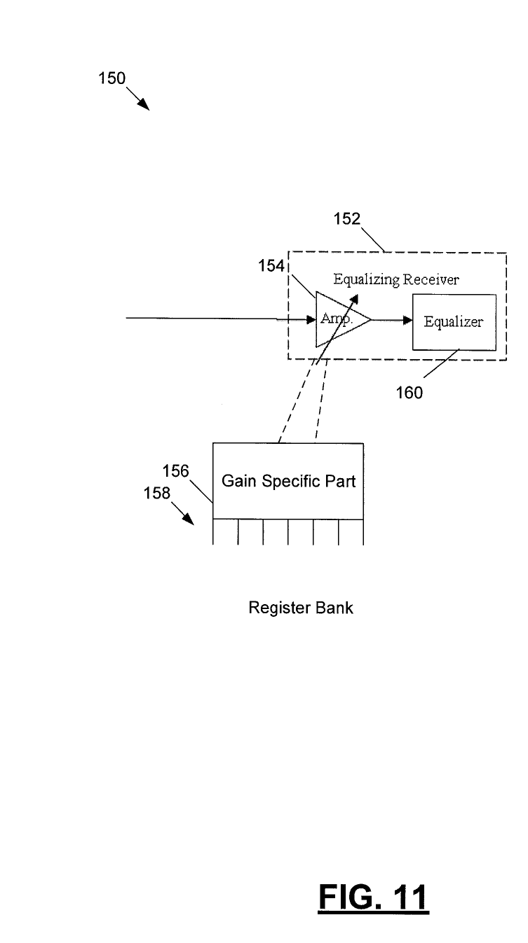

FIG. 11 is a block diagram depicting an equalizing receiver having a selectable gain flat-band amplifier that is controllable via integration of a gain specific part. A transmitted data signal is received by an equalizing receiver 152. The equalizing receiver 152 includes a selectable gain flat-band amplifier 154 for providing flat-band amplification to the received data signal. The flat-band amplifier 154 is controlled via insertion of a gain specific part 156. For example, a gain specific part 156 may be integrated into the flat-band amplifier 154 by interfacing one or more pins 158 of the gain specific part 156 with the flat-band amplifier 154. The flat-band amplifier 154 then applies a level of flat-band amplification to the received data signal according to the integrated gain specific part 156. The equalizing receiver 152 also includes an equalizer 160 for providing frequency dependent amplification to the received data signal. The configuration of FIG. 11 may be useful where needed flat-band gain levels are known and do not change frequently.

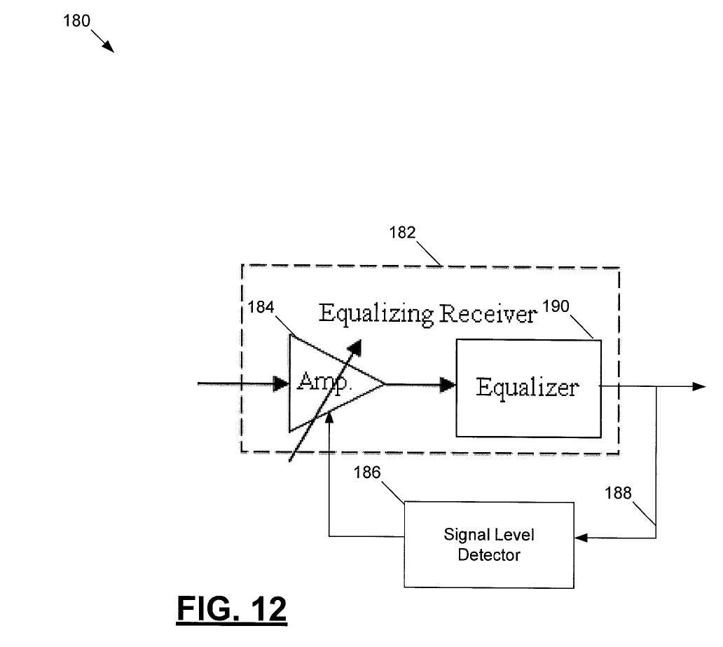

FIG. 12 is a block diagram depicting an equalizing receiver having a selectable gain flat-band amplifier that is controllable via a feedback loop. A transmitted data signal is received by an equalizing receiver 182. The equalizing receiver 182 includes a selectable gain flat-band amplifier 184 for providing flat-band amplification to the received data signal. The flat-band amplifier 184 is controlled by command signals from a signal level detector 186 positioned on a feedback loop 188. The feedback loop may originate from a number of positions in the transmission chain and implement a level of flat-band gain to bring a received data signal level into compliance with an expected range. For example, in the example of FIG. 12, the feedback loop 188 originates from the output of the equalizing receiver 182. Alternatively, the feedback loop 188 could originate immediately after the flat-band amplifier 184 or after other downstream circuitry such as a decoder. The signal level detector 186 compares a measurement of the output of the equalizing receiver 182, such as an average voltage level, to an expected value and applies a command signal to the flat-band amplifier 184, accordingly. For example, if a signal level of the output of the equalizing receiver 182 is lower than an expected value, the signal level detector 186 may issue a command signal to the flat-band amplifier 184 to apply a higher level of flat-band gain. The signal level detector 186 may include continuous and/or discrete components. The flat-band amplifier 184 applies a level of flat-band amplification to the received data signal according to the command from the signal level detector 186. The equalizing receiver 182 also includes an equalizer 190 for providing frequency dependent amplification to the received data signal. The configuration of FIG. 12 may be useful where the level of needed flat-band gain levels varies over time, for example, due to temperature variation.

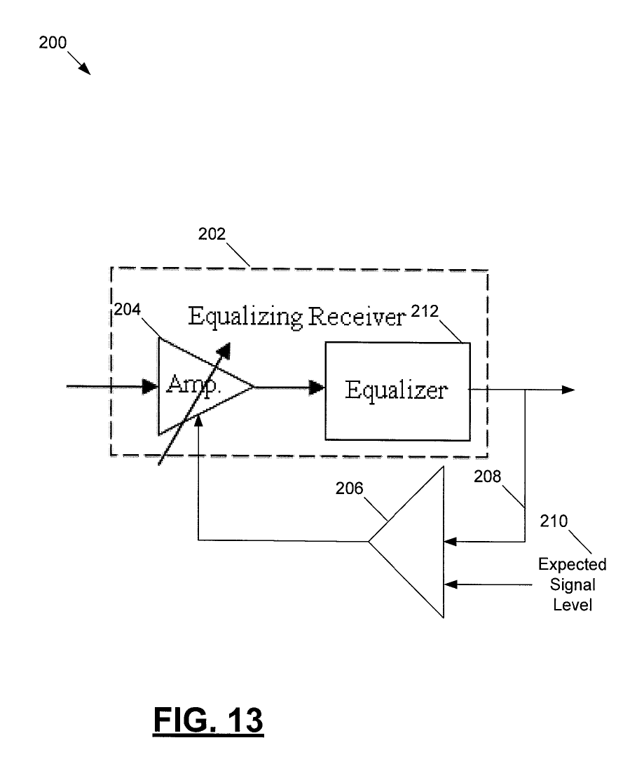

FIG. 13 is a block diagram depicting an equalizing receiver having a selectable gain flat-band amplifier that is controllable via a feedback loop that includes a comparator. A transmitted data signal is received by an equalizing receiver 202. The equalizing receiver 202 includes a selectable gain flat-band amplifier 204 for providing flat-band amplification to the received data signal. The flat-band amplifier 204 is controlled by command signals from a comparator 206 positioned on a feedback loop 208. The feedback loop may originate from a number of positions in the transmission chain and implement a level of flat-band gain to bring a received data signal level into compliance with an expected range. For example, if a signal is detected to be in a narrower than expected voltage range, the flat-band amplifier 204 may receive a signal from the comparator 206 to increase the flat-band gain provided to the received data signal. In the example of FIG. 13, the comparator 206 compares a measurement of the output of the equalizing receiver 202 to an expected signal level 210 and applies a command signal to the flat-band amplifier 204, accordingly. For example, if a signal level of the output of the equalizing receiver 202 is lower than an expected signal level 210, the comparator 206 may issue a command signal to the flat-band amplifier 204 to apply a higher level of flat-band gain. The equalizing receiver 202 also includes an equalizer 212 for providing frequency dependent amplification to the received data signal.

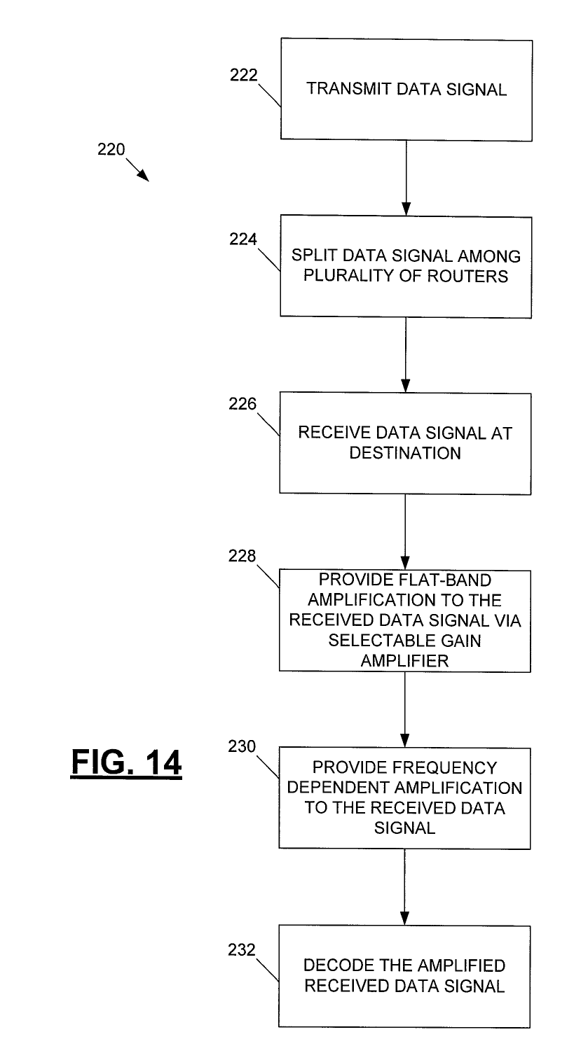

FIG. 14 is a flow diagram depicting a method for communicating a data signal. A data signal is transmitted along a communications line at 222. At 224, the transmitted data signal is split among a plurality of routers, each router configured to receive the data signal and forward the data signal along one or more output data paths. The data signal is received at a destination, as shown at 226, and at 228, flat-band amplification is provided to the received data signal via a selectable gain amplifier. At 230, a frequency dependent amplification is provided to the received data signal via an equalizer. The amplified received signal is then decoded at 232.

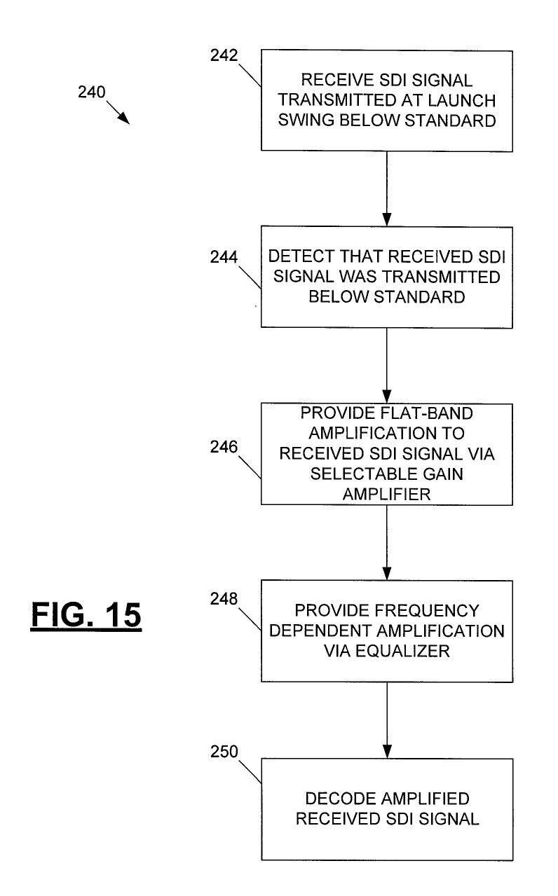

FIG. 15 is a flow diagram depicting a method for receiving a serial digital interface signal. At 242, an SDI signal transmitted at a launch swing below a prescribed launch swing standard is received. At 244, the receiver detects that the SDI signal was transmitted at the launch swing below the prescribed launch swing standard. At 246, flat-band amplification is provided to the received SDI signal via a selectable gain amplifier, and frequency dependent amplification is provided to the received SDI signal via an equalizer at 248. At 250, the amplified received SDI signal is decoded.

This written description uses examples to disclose the invention, including the best mode, and also to enable a person skilled in the art to make and use the invention. The patentable scope of the invention may include other examples.

It is claimed:

1. A method of communicating a data signal, comprising:
transmitting the data signal along a communications line;
splitting the transmitted data signal among one or more routers, each router configured to receive the data signal and forward the data signal along one or more output data paths;
receiving the data signal at a destination;
providing flat-band amplification to the received data signal via a selectable gain amplifier;
providing frequency dependent amplification to the received data signal via an equalizer; and
decoding the amplified received data signal.

2. The method of claim 1, wherein a gain associated with the selectable gain amplifier is selectable via a mechanical selecting mechanism, a register bank, or integration of a gain specific part.

3. The method of claim 1, wherein a gain associated with the selectable gain amplifier is automatically selected via a feedback loop.

4. The method of claim 3, further comprising:
measuring a signal level of the received data signal at the destination;
comparing the signal level of the received data signal to an expected signal level; and
selecting the gain associated with the selectable gain amplifier to be proportional to a difference between the expected signal level and the measured signal level of the received data signal.

5. The method of claim 2, wherein the gain associated with the selectable gain amplifier is selected based on a temperature measurement or a voltage measurement.

6. A method of receiving a serial digital interface (SDI) signal at a launch swing independent receiver, comprising:
receiving an SDI signal transmitted at a launch swing below a prescribed launch swing standard;
detecting that the received SDI signal was transmitted at the launch swing below the prescribed launch swing standard;
providing flat-band amplification to the received SDI signal via a selectable gain flat-band amplifier;
providing frequency dependent amplification to the received SDI signal via an equalizer; and
decoding the amplified received SDI signal.

7. The method of claim 6, wherein the prescribed launch swing standard is dictated by the Society of Motion Picture and Television Engineers.

8. The method of claim 6, wherein the received SDI signal is detected as being transmitted at the launch swing below the prescribed launch swing standard when the received SDI signal is received in a narrower than expected voltage range.

9. The method of claim 7, wherein the SDI signal is transmitted by a Society of Motion Picture and Television Engineers standard compliant transmitter at a launch swing below a prescribed launch swing of the Society of Motion Picture and Television Engineers standard by a first known deficiency magnitude, a gain of the selectable gain amplifier being set based on the first known deficiency magnitude prior to receiving the SDI signal.

10. The method of claim 9, further comprising:
measuring a signal level of the received SDI signal at the destination;
comparing the signal level of the received SDI signal to an expected signal level; and
refining the gain associated with the selectable gain amplifier to be proportional to an difference between the expected signal level and the measured signal level of the received SDI signal.

11. A system for communicating a data signal, comprising:
a transmitter configured to transmit a data signal along a communications line;
one or more routers among which the transmitted data signal is split, each router configured to receive the data signal and forward the data signal along one or more output data paths;
a receiver configured to receive the data signal at a destination;
a selectable gain amplifier configured to provide flat-band amplification to the received data signal;
an equalizer configured to provide frequency dependent amplification to the received data signal; and
a decoder configured to decode the amplified received data signal.

12. The system of claim 11, wherein a gain associated with the selectable gain amplifier is selectable via a mechanical selecting mechanism, a register bank, or the integration of a gain specific part.

13. The system of claim 11, further comprising a feedback loop for automatically selecting a gain associated with the selectable gain amplifier.

14. The system of claim 13, further comprising:
a signal level detector configured to measure a signal level of the received data signal at the destination, the signal level detector comprising:
a comparator configured to compare the signal level of the received data signal to an expected signal level and to select the gain associated with the selectable gain amplifier to be proportional to an difference between the expected signal level and the measured signal level of the received data signal.

15. The system of claim 12, further comprising a thermometer or a signal level detector, wherein the gain associated with the selectable gain amplifier is selectable based on a temperature measurement from the thermometer or a voltage measurement from the signal level detector.

16. A system for applying selectable pre-amplification to a serial digital interface (SDI) signal, comprising:
an launch swing independent SDI signal receiver configured to receive an SDI signal from a connected co-axial cable transmission line, the SDI signal receiver further including:
a transmission launch swing detector configured to detect whether the received SDI signal was transmitted at a launch swing below a prescribed launch swing standard;
a flat-band amplifier configured to amplify the received SDI signal according to a selectable gain upon detection that the received SDI signal was transmitted at the launch swing below the prescribed launch swing standard;
an equalizer configured to provide frequency dependent amplification to the received SDI signal; and
a decoder for decoding the amplified received SDI signal.

17. The system of claim 16, wherein the prescribed launch swing standard is dictated by the Society of Motion Picture and Television Engineers.

18. The system of claim 16, wherein the received SDI signal is detected as being transmitted at the launch swing below the prescribed launch swing standard by the transmission launch swing detector when the received SDI signal is received in a narrower than expected voltage range.

19. The system of claim 17, wherein the SDI signal is transmitted by a Society of Motion Picture and Television Engineers standard compliant transmitter at a launch swing below a prescribed launch swing of the Society of Motion Picture and Television Engineers standard by a first known deficiency magnitude, a gain of the selectable gain amplifier being set based on the first known deficiency magnitude prior to receiving the SDI signal.

20. The system of claim 19, further comprising:
a signal level detector configured to measure a signal level of the received SDI signal at the destination, the signal level detector comprising:
a comparator configured to compare the signal level of the received SDI signal to an expected signal level and to refine the gain associated with the selectable gain amplifier to be proportional to an difference between the expected signal level and the measured signal level of the received data signal.
